(19) United States
(12) Patent Application Publication
(10) Pub. No.: US 2006/0109537 A1
(43) Pub. Date: May 25, 2006

(54) Optical scanning apparatus and image formation device

(75) Inventor: Fumiya Hisa, Kanagawa (JP)

Correspondence Address: MORGAN LEWIS & BOCKIUS LLP, 1111 PENNSYLVANIA AVENUE NW, WASHINGTON, DC, 20004, US

(73) Assignee: FUJI XEROX CO., LTD

(21) Appl. No.: 11/284,955

(22) Filed: Nov. 23, 2005

(30) Foreign Application Priority Data
Nov. 25, 2004 (JP) 2004-340956

(51) Int. Cl. G02B 26/08

(52) U.S. Cl. 359/206

(57) ABSTRACT

An optical scanning apparatus comprises an optical deflector at which a light beam emitted from a light source is incident on a polygon mirror, and the polygon mirror is rotated for deflectingly scanning the light beam; an optical container accommodating the optical deflector, the optical deflector being disposed at a vicinity of an inner wall face of the optical container; and a baffle member disposed between an outer peripheral face of the polygon mirror and the inner wall face of the optical container, the baffle member regulating an airflow, which occurs along an outer periphery of the polygon mirror in accordance with the rotation.

CROSS-REFERENCE TO RELATED APPLICATION

This application claims priority under 35 USC 119 from Japanese Patent Application No. 2004-340956, the disclosure of which is incorporated by reference herein.

### BACKGROUND OF THE INVENTION

1. Field of the Invention

The present invention relates to an optical scanning apparatus and an image formation device.

2. Description of the Related Art

In an electrophotography system image formation device, a light beam is deflected for scanning by an optical deflector, which is installed at an optical scanning apparatus, and is focused on a photosensitive drum by an optical system for forming an image market in which a polygon mirror, which utilizes an oil pressure bearing, and a motor are installed at a printed circuit board, which serves as a base of the optical deflector, and electronic components, which constitute a driving control circuit for controlling rotary driving of the polygon mirror and the motor, and suchlike are mounted at the printed circuit board. Such a unitized optical deflector product is inexpensive and highly versatile, and has a further advantage in that a task of assembly to an optical scanning apparatus, detachment and removal for maintenance, replacement at times of breakage, and the like are simple. Accordingly, it is expected that these products will be widely used hereafter.

FIG. 13 shows an example in which an optical deflector 204 is mounted inside a housing 202 of an optical scanning apparatus 200. The optical deflector 204 is formed as a unit as described above, with a polygon mirror 208 and a motor and the like at a printed circuit board 206. In this optical scanning apparatus 200, in order to reduce the size of the overall apparatus, as shown in FIG. 13, the optical deflector 204 is disposed close to inner wall faces of the housing 202, and structure is such that, while space for disposition of the optical deflector 204 is assured, unnecessary space around the optical deflector 204 is narrowed.

However, with this structure, with rotation of the polygon mirror 208, air flows in between the polygon mirror 208 and a corner portion 210 of the inner wall faces of the housing 202, from an upstream side in a direction of rotation. This air swirls and eddies in the vicinity of the 210 (see the arrows AR in the drawing). Consequently, there are inconsistencies in rotation of the polygon mirror 208, and variations in density of an image (hunting) become large, which is a problem.

Now, among optical deflectors (rotating apparatuses) in which a polygon mirror employing an oil pressure bearing is rotated at high speed, there are optical deflectors in which, in order to prevent rotation from becoming unstable even at ranges with less dynamic balance, pressure is generated between the housing and the polygon mirror by magnetism or air so as to make rotation characteristics more satisfactory. Specifically, a magnetic body is provided at the polygon mirror and a permanent magnet is provided at a position of the housing corresponding to that magnetic body. Hence, pressure (an attractive force) is applied to the polygon mirror by magnetism. Alternatively, air pressure is provided at the housing, at a location at which a separation between an inner face of the housing and an outer peripheral face of the polygon mirror is narrowed, and air pressure is generated between the housing and the polygon mirror. Thus, pressure is applied to the polygon mirror.

However, with the techniques described above, in the case in which magnetic force is employed, the magnetic body provided at the polygon mirror protrudes from a lower face thereof. Consequently, a wind-like sound is generated by this protruding portion during rotation. Moreover, forming a pressure that is appropriate to a rotation speed of the polygon mirror is difficult. Furthermore, because variations over time and temperature dependencies of the magnets are large, there is a risk that it will not be possible to maintain stable rotation characteristics.

On the other hand, in a case in which air pressure is employed, because the shape of a housing is fixed, it is difficult to match the air pressure to a suitable gap in accordance with a rotation speed of the polygon mirror. For example, if a gap is too wide, the effect is weakened, and if a gap is too narrow, pressure dissipation may lead to an increase in applied current, amounts of heat that are generated increase, and noise is generated. Moreover, an optimal value of a gap is specific only for a particular optical system (polygon mirror diameter). Therefore, if the optical system is changed, the housing must be redesigned, so versatility is lost. Furthermore, because structures (types) of the optical deflector are limited to types that are assembled from below the housing, it is not possible to apply this technique to general-purpose unitized optical deflectors, as described earlier.

### SUMMARY OF THE INVENTION

In consideration of the circumstances described above, the present invention provides an optical scanning apparatus and an image formation device.

An aspect of the present invention provides an optical scanning apparatus including: an optical deflector at which a light beam emitted from a light source is incident on a polygon mirror, and the polygon mirror is rotated for deflectingly scanning the light beam; an optical container accommodating the optical deflector, the optical deflector being disposed at a vicinity of an inner wall face of the optical container; and a baffle member disposed between an outer peripheral face of the polygon mirror and the inner wall face of the optical container, the baffle member regulating an airflow, which occurs along an outer periphery of the polygon mirror in accordance with the rotation.

Another aspect of the present invention provides an optical scanning apparatus including: an optical deflector at which a light beam emitted from a light source is incident on a polygon mirror, and the polygon mirror is rotated for deflectingly scanning the light beam; an optical container accommodating the optical deflector, the optical deflector being disposed at a vicinity of an inner wall face of the optical container; and a baffle member disposed between an outer peripheral face of the polygon mirror and the inner wall face of the optical container, the baffle member regulating an airflow, which occurs along an outer periphery of the polygon mirror in accordance with the rotation, wherein the baffle member has flexibility, a fixing portion that fixes the optical deflector at the optical container, the fixing portion being used for fixing the baffle member in association with the optical deflector, a screen portion is provided at the baffle member, the screen portion screening so that stray light occurring in the optical container is not incident on the polygon mirror, a contacting portion is provided at the baffle member, the contacting portion touching a heat source portion which is provided at the optical deflector, and the baffle member touches the inner wall face of the optical container.

### BRIEF DESCRIPTION OF THE DRAWINGS

Embodiments of the present invention will be described in detail based on the following figures, wherein:

FIG. 1 is a schematic view showing structure of an image formation device according to a first embodiment of the present invention;

FIG. 2 is a perspective view showing optical scanning apparatuses according to the first embodiment of the present invention;

FIG. 3 is a plan view showing principal structural components of an optical scanning apparatus according to the first embodiment of the present invention;

FIG. 4 is a perspective view showing principal structural components of the optical scanning apparatus according to the first embodiment of the present invention;

FIG. 5 is a diagram showing light paths of the optical scanning apparatuses according to the first embodiment of the present invention;

FIG. 6 is a vertical sectional view showing an optical deflector according to the first embodiment of the present invention;

FIG. 7 is a plan view showing a vicinity of a mounting portion of the optical deflector according to the first embodiment of the present invention;

FIG. 8A is a perspective view showing a baffle plate relating to the first embodiment of the present invention;

FIG. 8B is a diagram showing a positional relationship of the polygon mirror and the baffle plate;

FIG. 9 is a distribution chart comparing hunting distributions according to presence or absence of the baffle plate;

FIG. 10 is a perspective view showing a vicinity of a baffle plate and a mounting portion of an optical deflector relating to a second embodiment of the present invention;

FIG. 11 is a perspective view showing a vicinity of a baffle plate and a mounting portion of an optical deflector relating to a third embodiment of the present invention;

FIG. 12 is a plan view showing a state in which a baffle plate is applied in an optical scanning apparatus relating to a fourth embodiment of the present invention; and

FIG. 13 is a perspective view showing a vicinity of a mounting portion of an optical deflector of a conventional optical scanning apparatus.

### DETAILED DESCRIPTION OF THE INVENTION

Hereinbelow, examples of embodiments of the present invention will be described in detail with reference to the drawings.

### First Embodiment

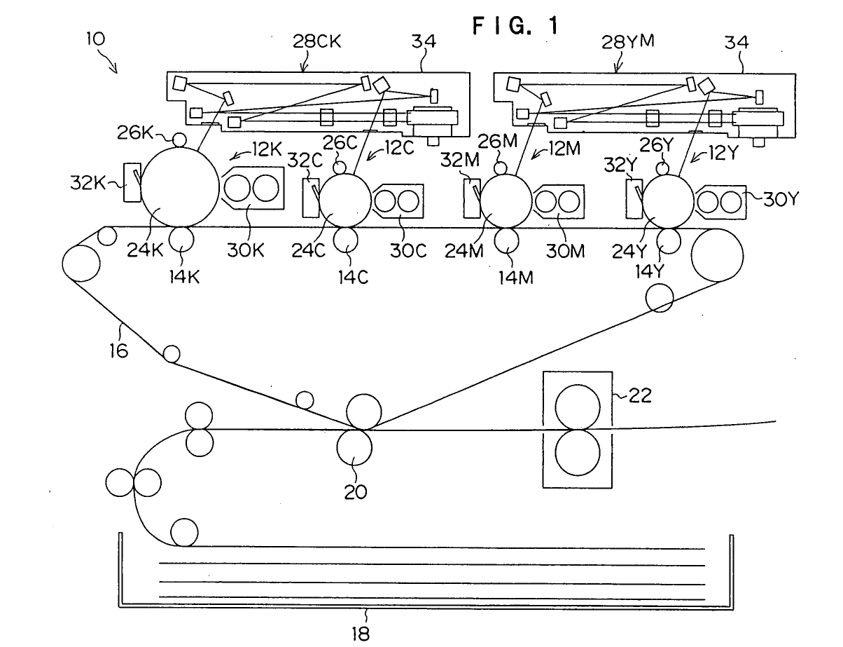

An image formation device 10 relating to the present embodiment is provided with an optical scanning apparatus 28CK and an optical scanning apparatus 28YM, as shown in FIG. 1. The optical scanning apparatus 28CK scans for exposing a photosensitive body drum 24C and a photosensitive body drum 24K, and is provided with optical systems corresponding to each of the colors C (cyan) and K (black). The optical scanning apparatus 28YM scans for exposing a photosensitive body drum 24Y and a photosensitive body drum 24M, and is provided with optical systems corresponding to each of the colors Y (yellow) and M (magenta).

The image formation device 10 is also provided with electrophotography units 12Y, 12M, 12C and 12K, which form toner images of the four colors Y (yellow), M (magenta), C (cyan) and K (black). The electrophotography unit 12Y is structured with a charging apparatus 26Y, the optical scanning apparatus 28YM, a developing apparatus 30Y, a transfer apparatus 14Y and a cleaning apparatus 32Y disposed around the photosensitive body drum 24Y. The electrophotography units 12M, 12C and 12K have similar structures.

The image formation device 10 is also provided with an intermediate transfer belt 16, a transfer apparatus 20 and a fixing apparatus 22. Respective toner images are layered by the transfer apparatuses 14Y to 14K to form a color toner image on the intermediate transfer belt 16. The transfer apparatus 20 transfers the color toner image that has been transferred onto the intermediate transfer belt 16 to paper, which is supplied from a tray 18. The fixing apparatus 22 melts and fixes the color toner image that has been transferred onto the paper.

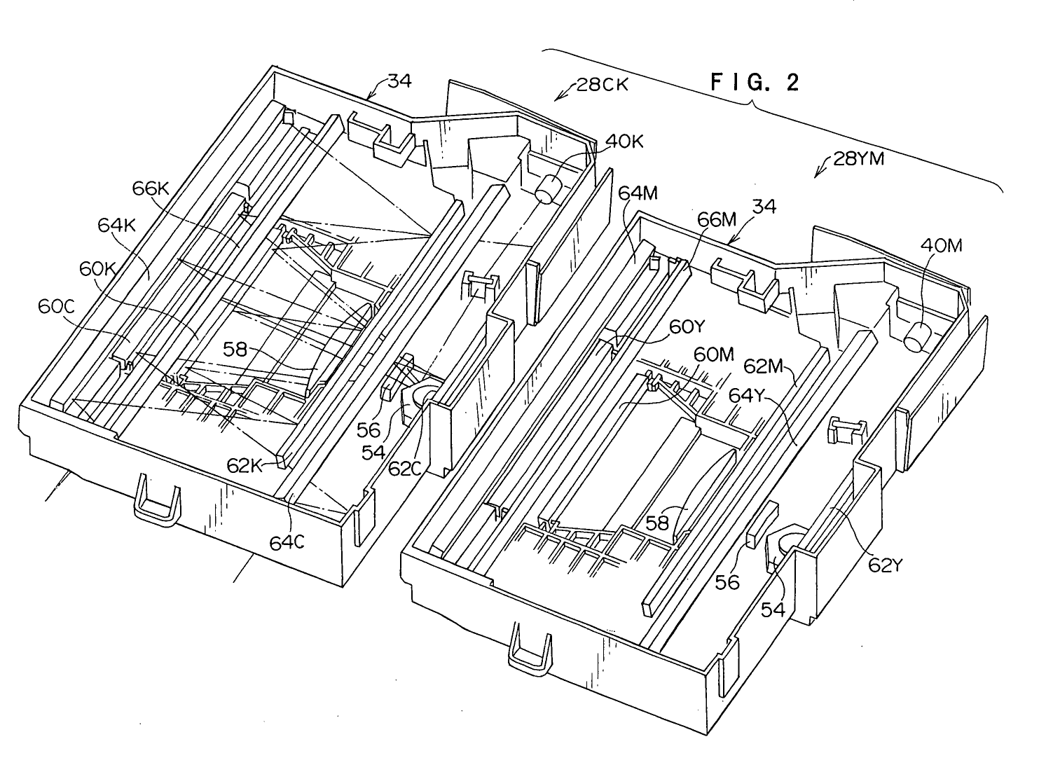

As shown in FIG. 2, the optical scanning apparatuses 28CK and 28YM are provided with rectangular box-form housings 34. Herein, because internal structures of the optical scanning apparatuses 28CK and 28YM are substantially the same, only the optical scanning apparatus 28CK will be described.

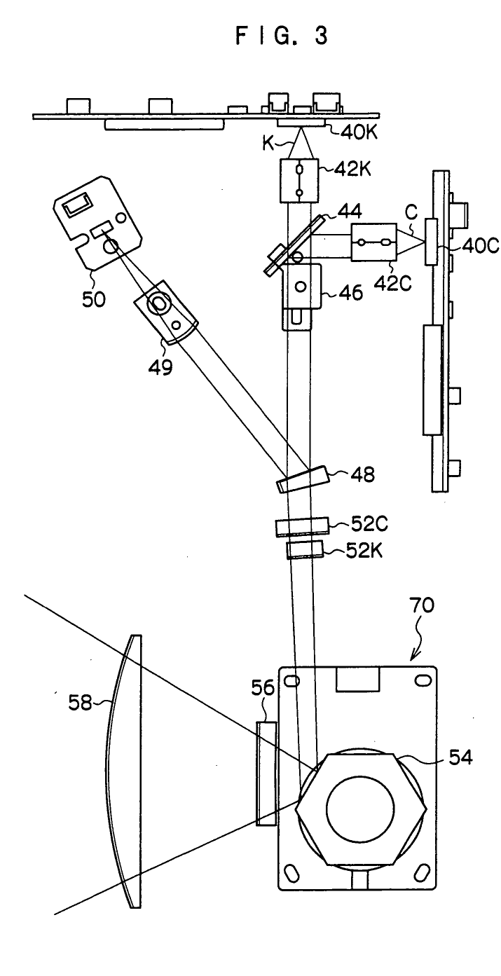

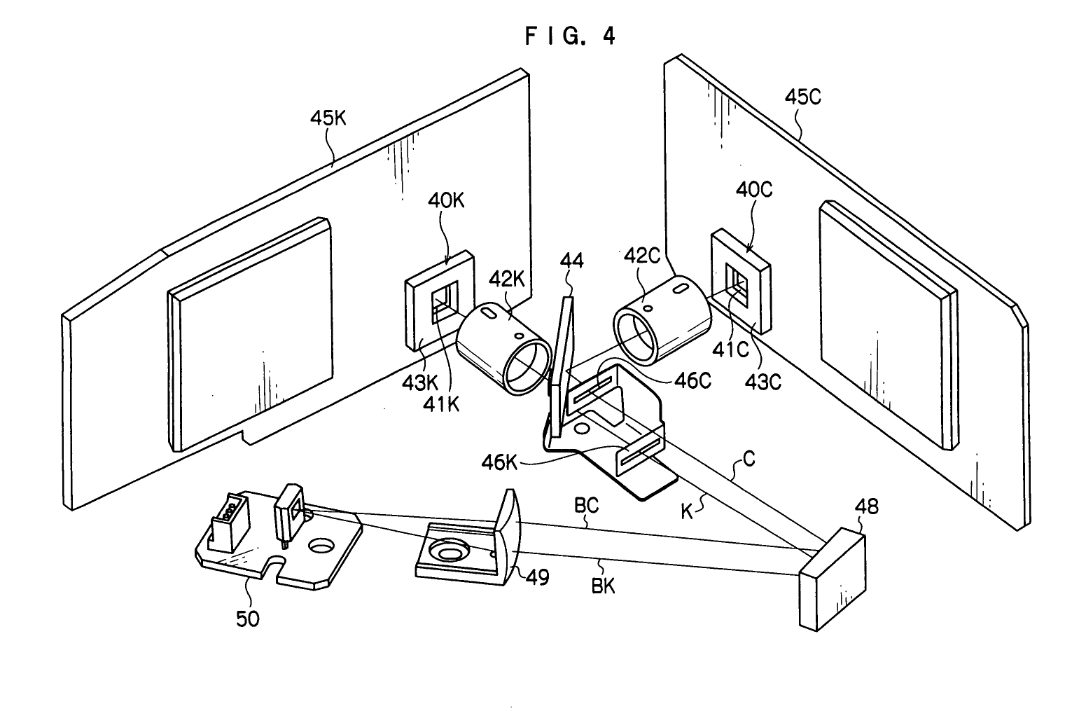

As shown in FIGS. 3 and 4, a light source portion 40K, which emits a light beam corresponding to the color K, and a light source portion 40C, which emits a light beam corresponding to the color C, are disposed in the housing 34 such that emission directions thereof are substantially at 90° to one another. In the present embodiment, surface emission-type semiconductor lasers are employed as the emitting light sources. As shown in FIG. 4, the light source portions 40C and 40K are structured with surface emission laser chips 41C and 41K and retaining members 43C and 43K. The surface emission laser chips 41C and 41K are formed to be capable of simultaneously emitting plural optical lasers. The retaining members 43C and 43K are members for retaining the surface emission laser chips 41C and 41K, are referred to with the common term LCC (leadless chip carrier), and ceramics are employed as materials thereof. The surface emission laser chips 41C and 41K are electrically connected, through the retaining members 43C and 43K, to circuit boards 45C and 45K, respectively, at which electrical circuits are mounted.

The light source portion 40C which emits the light beam C and the light source portion 40K which emits the light beam K are disposed to be offset in a height direction, and the light beam C and the light beam K are arranged so as to be a predetermined distance apart in the height direction.

A collimator lens unit 42K, for making light of the light beam K parallel, is disposed on an optical path of the light beam K emitted from the light source portion 40K. The light beam K that has passed through the collimator lens unit 42K passes beneath a reflection mirror 44, is incident at a slit plate 46K and is incident on a half-mirror 48, which is disposed on the optical path. The half-mirror 48 divides the light beam K into a transmitted light beam K and a reflected light beam BK in a predetermined ratio. The light beam BK is incident at an optical power monitor 50. Because a surface emission optical laser is employed in the present embodiment, it is not possible to obtain light for light amount control from a backbeam. Therefore, a portion of the light beam emitted in a forward direction is utilized by dividing with the half-mirror 48. The light beam K that has passed through the half-mirror 48 passes through a cylindrical lens 52K and is incident at a polygon mirror 54 which is disposed on the optical path, as shown in FIG. 3.

Meanwhile, a collimator lens unit 42C, for making light of the light beam C parallel, is disposed on an optical path of the light beam C emitted from the light source portion 40C. The light beam C that has passed through the collimator lens unit 42C is deflected by the reflection mirror 44, is incident at a slit plate 46C and is incident on the half-mirror 48 disposed on the optical path. The half-mirror 48 divides the light beam C into a transmitted light beam C and a reflected light beam BC in a predetermined ratio. The light beam BC is incident at the optical power monitor 50. The light beam C that has passed through the half-mirror 48 passes through a cylindrical lens 52C and is incident at the polygon mirror 54, of an optical deflector 70 which is disposed on the optical path, as shown in FIG. 3.

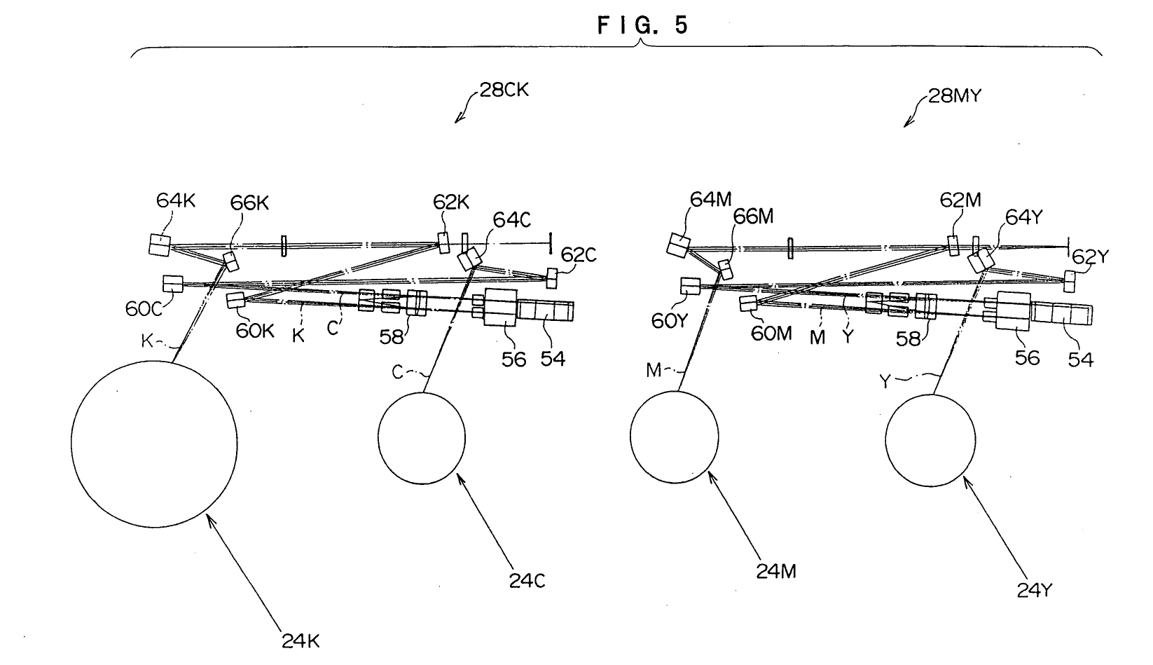

Plural reflection mirror faces are provided at the polygon mirror 54. As shown in FIG. 5, the light beams C and K that are incident at the polygon mirror 54 are deflectingly reflected by the reflection mirror faces and enter fθ lenses 56 and 58. The polygon mirror 54 and the fθ lenses 56 and 58 are of sizes which are capable of scanning the light beams C and K simultaneously.

The light beams C and K which have passed through the f-θ lens 56 are separated and are reflected at respective cylindrical mirrors 60C and 60K, which have power in a sub-scanning direction. The light beam K that has been reflected by the cylindrical mirror 60K is doubled back to a reflection mirror 62K, is then deflected by a cylindrical mirror 64K and a reflection mirror 66K, and is focused at the photosensitive body drum 24K to form an electrostatic latent image.

Meanwhile, the light beam C that has been reflected by the cylindrical mirror 60C is doubled back to a reflection mirror 62C, is then deflected by a cylindrical mirror 64C, and is focused at the photosensitive body drum 24C to form an electrostatic latent image.

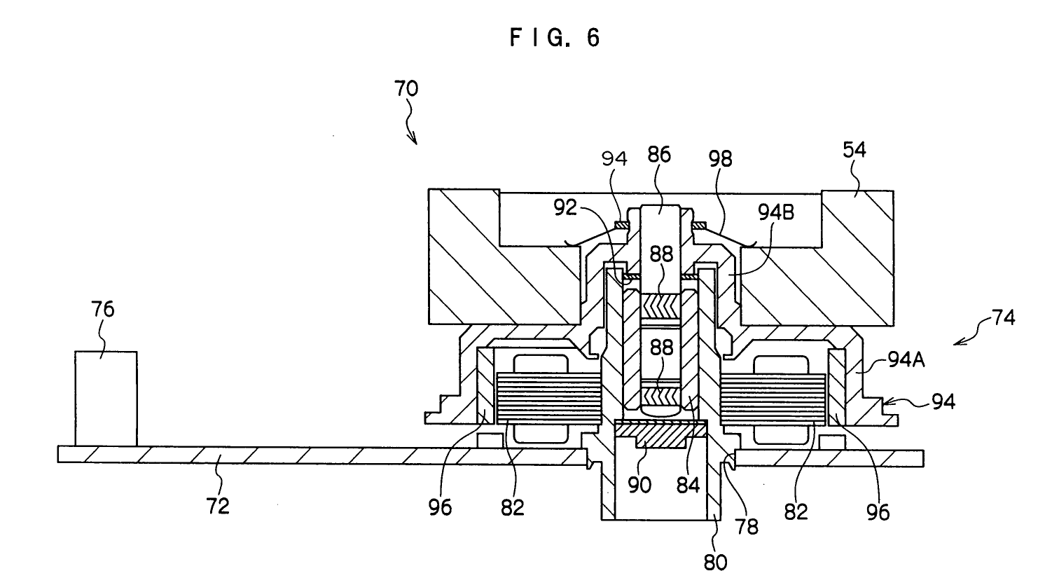

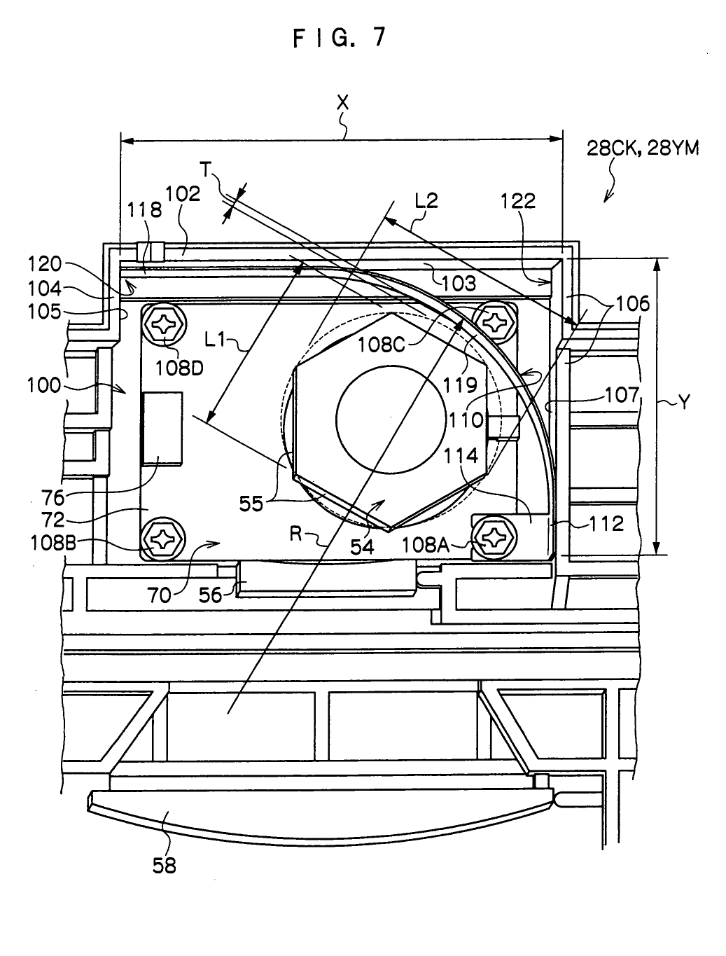

FIG. 6 shows the optical deflector 70 relating to the present embodiment as described above. FIG. 7 shows a state in which the optical deflector 70 has been assembled to be accommodated inside the housing 34 of the optical scanning apparatus 28CK or the optical scanning apparatus 28YM.

This optical deflector 70 is a commercially available product. As shown in FIGS. 6 and 7, a printed circuit board 72, with a rectangular shape in plan view, is provided to serve as a base of the optical deflector 70.

The polygon mirror 54 and a motor 74 are disposed to be offset to one side relative to a central portion of the printed circuit board 72. Electrical components (not shown), which structure a driving control circuit for controlling rotational driving of the polygon mirror 54 and the motor 74, are mounted at the printed circuit board 72. A connector 76, at which the light sources and a signal cable are connected, is mounted at an end portion at the other side of the printed circuit board 72.

Toward the one side of the printed circuit board 72, a circular aperture 78 is formed. A statorside fixed shaft 80, which structures the motor 74, is pushed in at the aperture 78.

The fixed shaft 80 is formed in a tubular shape as shown in FIG. 6, and plural driving coils 82 are mounted at an outer peripheral face of the fixed shaft 80, at substantially equal intervals along a peripheral direction. A sleeve 84 is inserted into the fixed shaft 80. A rotor-side rotation axle 86, which structures the motor 74, is inserted into the sleeve 84 with a predetermined gap (of several microns) formed therebetween.

At a vertical end portion of an outer peripheral face of an inserted portion of the rotation axle 86, herringbone grooves 88, with depths of several microns, are plurally formed along the peripheral direction in order to structure a pressure bearing. An oil (a lubricant) is charged into the fixed shaft 80, and is sealed in by sealing members 90 and 92 such that the oil will not leak out.

A retaining member 94, which is formed in a circular bowl shape, is pressed onto and fixed at an upper end portion of the rotation axle 86. At a lower portion side of the retaining member 94, a large-diameter tubular portion 94A is provided, which covers the above-mentioned driving coils 82. A ring-form driving magnet 96, which opposes outer peripheral faces of the driving coils 82, is mounted at an inner peripheral face of the large-diameter tubular portion 94A. A small-diameter tubular portion 94B is provided at an upper portion of the retaining member 94. The polygon mirror 54 is fitted onto the small-diameter tubular portion 94B, and is attached by a fixing spring 98. This polygon mirror 54 is fabricated of aluminum and formed in a polygonal column shape. The surface of each side of the polygon mirror 54 is machined to a mirror surface.

Hence, at this optical deflector 70, the driving control circuit provided at the printed circuit board 72 controls so as to apply voltage to the driving coils 82, current flows in the driving coils 82, an electromagnetic induction effect is exerted by the magnetic field of the driving magnet 96 opposing the driving coils 82 with this current, and a rotary driving force is generated at the driving magnet 96. The polygon mirror 54 is rotated at high speed by this rotary driving force. Further, in accordance with this rotation, pressure is generated between the sleeve 84 and the rotation axle 86 inside the fixed shaft 80, and a pressure bearing is formed which supports the rotation axle 86 in radial directions by this pressure.

Further, as is shown in FIG. 2 and FIG. 7, the optical deflector 70 is disposed, in the housing 34 of the optical scanning apparatus 28CK or 28YM, close to side walls of the housing 34.

As shown in FIG. 7, the housing 34 of the present embodiment is designed to be small with unnecessary spaces around the optical deflector 70 being narrowed, while space for disposition of the optical deflector 70 is maintained. Side wall shapes are formed as protruding forms from an optical deflector mounting portion 100 of the housing 34. In the following descriptions, of the protruding-form side walls of the housing 34, a wall portion which is located at an upper side in FIG. 7 is described as a rear wall portion 102, a wall portion which is located at a left side is described as a left side wall portion 104, and a wall portion which is located at a right side is described as a right side wall portion 106.

As shown in FIG. 7, a length direction of the printed circuit board 72 is aligned with a left-right direction of the housing 34, and the optical deflector 70 is mounted on a bottom face of the housing 34 (on the optical deflector mounting portion 100). The printed circuit board 72 is attached by four corners thereof being fixed with four screws 108A, 108B, 108C and 108D.

A baffle plate 110 is provided between the polygon mirror 54 and the rear wall portion 102 and right side wall portion 106, and more specifically, between an outer peripheral face (side faces 55) of the polygon mirror 54 and an inner wall face 103 of the rear wall portion 102 and an inner wall face 107 of the right side wall portion 106.

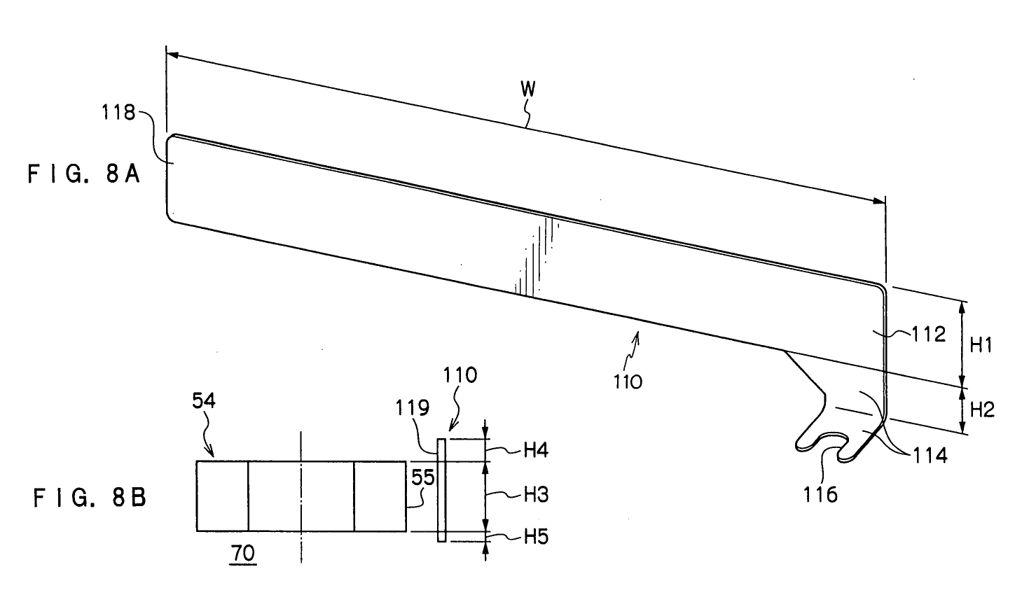

As shown in FIG. 8A, this baffle plate 110 is a thin plate which is formed as a long strip with a substantially rectangular shape. In the present embodiment, the baffle plate 110 is fabricated of a metal such as stainless steel or the like, and is formed to have flexibility and be resiliently deformable.

At one end portion 112 of the baffle plate 110, a fixing portion 114 is provided. The fixing portion 114 is projected downward and is formed to be inflected through a substantial right angle partway therealong. A ‘U’-shaped slot portion 116 is formed at a distal end portion of this fixing portion 114. An other end portion 118 of the baffle plate 110 has a straight form.

Hence, as shown in FIG. 7, the other end portion 118 of the baffle plate 110 is pushed in against a corner portion 120 formed by the rear wall portion 102 and the left side wall portion 104. In this state, the baffle plate 110 is curved so as to reach around the polygon mirror 54, and the baffle plate 110 is assembled to the optical deflector mounting portion 100 by the slot portion 116 of the fixing portion 114 being fastened with the screw 108A, which fixes a front-right corner portion of the optical deflector 70 (i.e., the printed circuit board 72).

A resilient restoring force is generated in the baffle plate 110 when the baffle plate 110 is curvingly deformed in this manner. A distal end of the other end portion 118 is abutted against the corner portion 120 (i.e., an inner wall face 105 of the left side wall portion 104) by this resilient restoring force, and a rear face of the other end portion 118 is abutted against the inner wall face 103 of the rear wall portion 102 and thus positioned. Because of frictional force which is generated between the other end portion 118 and the corner portion 120 (i.e., the inner wall face 105) and the inner wall face 103, the other end portion 118 is maintained in this state without being shifted in position, even in response to vibrations, impacts and the like.

Before the fixing portion 114 is fixed by the screw 108A, a rear face of the one end portion 112 is, naturally, pressed against the inner wall face 107 of the right side wall portion 106 by the inherent resilient restoring force of the baffle plate 110. The one end portion 112 is fixed without any change from this pressed state.

As a result, as shown in the drawings, a curved portion 119 (i.e., a substantially central portion) of the baffle plate 110 serves as a circular-arc form curved face with a constant curvature (a face with radius R), which is free of unevennesses and the like and is smooth. As shown in FIG. 8B, this curved portion 119 is disposed to oppose the side faces 55 of the polygon mirror 54.

Now, in the present embodiment, dimensions of the various portions are as follows.

With regard to the baffle plate 110, a length direction length dimension of the baffle plate 110 (a width dimension) W=115 mm, a height dimension of a main body portion of the baffle plate H1=14 mm, a height dimension of the fixing portion 114 H2=8 mm (refer to FIG. 8A), and a thickness dimension is 0.2 mm.

With regard to the polygon mirror 54, the diameter of a circle inscribed in the polygon L1=34.64 mm, diameter of a circumscribed circle L2=40 mm (refer to FIG. 7), a thickness (height) dimension H3=10 mm (refer to FIG. 8B), and a maximum speed of rotation is 13,000 rpm.

With regard to the side walls of the housing 34, a width direction length dimension of the rear wall portion 102 X=80 mm, and a front-rear direction length dimension of the right side wall portion 106 Y=55 mm (refer to FIG. 7).

Furthermore, in the state in which the baffle plate 110 has been assembled, an over portion of the main body portion (i.e., the curved portion 119) of the baffle plate 110 relative to the polygon mirror 54 protrudes by H4=3 mm, and a corresponding under portion protrudes by H5=1 mm (refer to FIG. 8B). Further, the radius of the baffle plate 110 at the curved portion 119 R=41.6 mm, and a minimum gap between the curved portion 119 and the polygon mirror 54 T=3 mm (refer to FIG. 7).

Next, operations of the present embodiment will be described. As described above, the optical deflector 70 which is mounted at the optical deflector mounting portion 100 of the housing 34 is disposed near the inner wall face 103 of the rear wall portion 102 and the inner wall face 107 of the right side wall portion 106. As mentioned above, at this optical deflector 70, a light beam emitted from each light source portion 40 is incident at the polygon mirror 54, and the light beam is deflectingly scanned by the polygon mirror 54 being rotated at high speed. Airflows that are generated along the circumferential direction of the polygon mirror 54 in accordance with rotation of the polygon mirror 54 are regulated by the baffle plate 110 at a vicinity of a corner portion 122, which is formed by the rear wall portion 102 and the right side wall portion 106 of the housing 34 (see FIG. 7). Thus, swirls, eddies and the like may not occur at the vicinity of the corner portion 122. Accordingly, inconsistencies in rotation of the polygon mirror 54 due to such airflow turbulence may be suppressed.

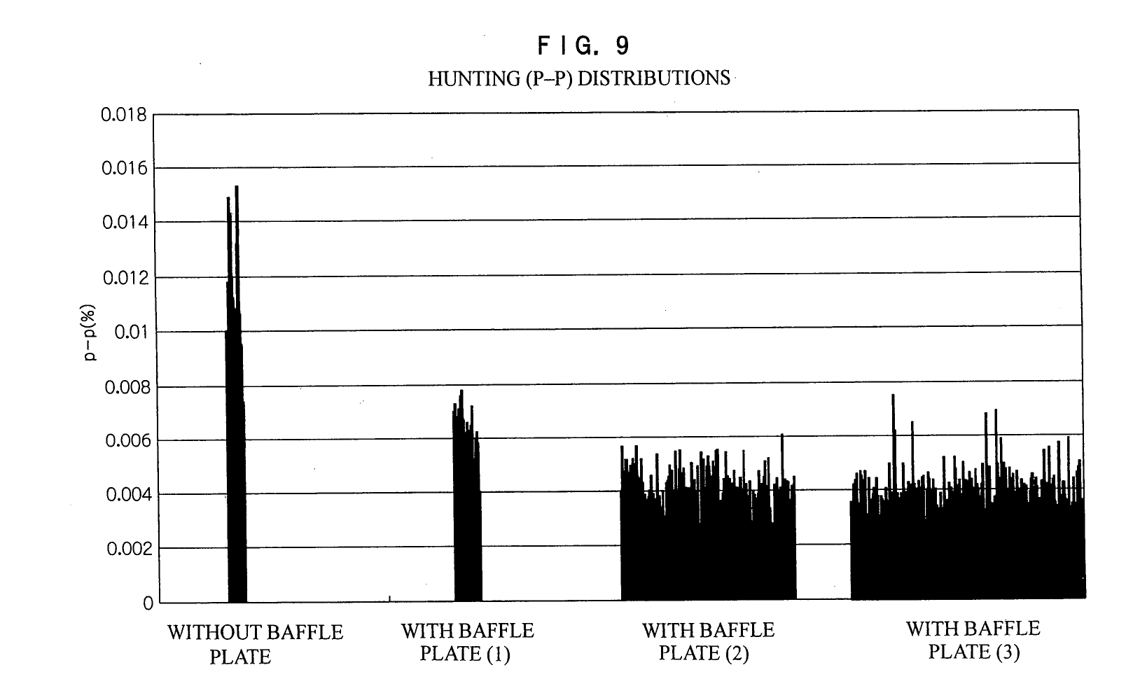

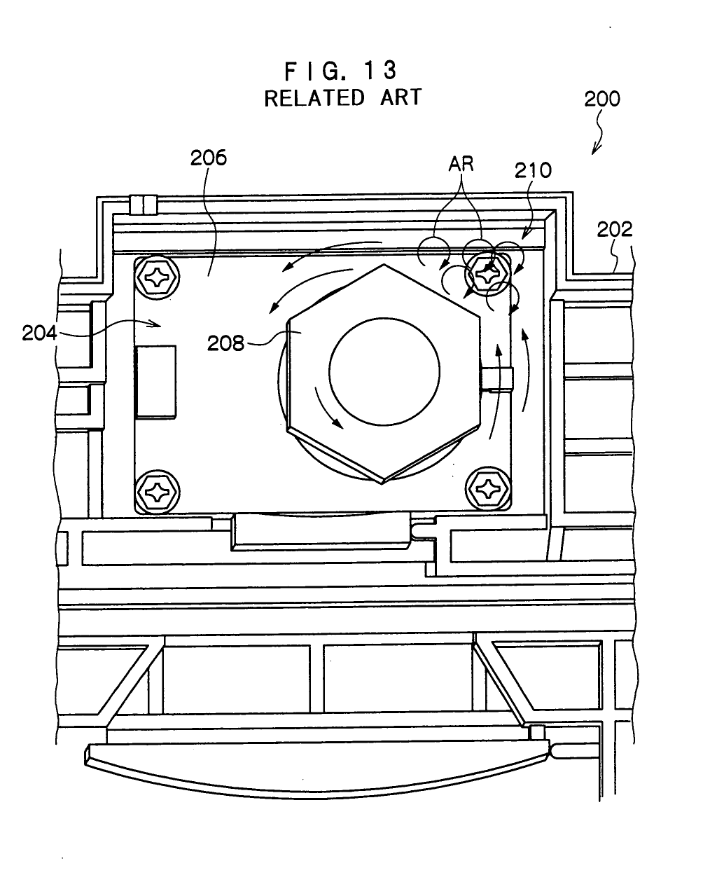

FIG. 9 shows distributions (p-p) of hunting measured, respectively, in three tests in which the above-described baffle plate 110 is provided and in a case in which there is no baffle plate, as shown in FIG. 13.

In a case in which the polygon mirror 54 is made thicker in order to deflect a plurality of light beams (for two colors) with the single polygon mirror 54, as in the present embodiment, or in a case in which stiffness of the pressure bearing of the motor 74 is weaker because the polygon mirror 54 is rotating at a lower speed, adverse effects due to air turbulence are more strongly experienced, and inconsistencies in rotation are more likely to be larger. However, even with such structures, as is seen from FIG. 9, hunting is greatly ameliorated by the provision of the baffle plate 110 (i.e., a level of hunting is reduced by approximately half).

Further, the baffle plate 110 of the present embodiment is structured as a separate body from the housing 34. When the baffle plate 110 is a separate body from the housing 34, if the type, optical system or the like of the optical deflector is changed, it is possible to respond with ease, just by a temporary redesign. Furthermore, because there are no variations over time or temperature dependencies as in a conventional case in which magnetic force (magnets) is employed, it is possible to keep rotation characteristics of the polygon mirror 54 stable over long periods. Therefore, with the image formation device 10 of the present embodiment which is provided with the optical scanning apparatuses 28CK and 28YM described above, high quality images in which density variations are suppressed can be formed.

Because the baffle plate 110 features flexibility and is resiliently deformable, it can be possible to adapt to a change in the optical system, a change in the gap between outer peripheral faces of the polygon mirror 54 and inner peripheral faces of the housing 34, a change in shape of the housing 34, or the like, simply by varying the shape of deformation of the baffle plate 110. Thus, versatility of the baffle plate 110 for improving rotation characteristics of the polygon mirror 54 is further enhanced. Further still, because the baffle plate 110 is formed by a metal plate, machining is simple and the baffle plate 110 may be fabricated inexpensively.

Further yet, in the present embodiment, because there is no need to separately provide dedicated fixing unit that fixes the baffle plate 110, structures of the optical scanning apparatuses 28CK and 28YM may be kept simple and inexpensive. Moreover, the baffle plate 110 may be fixed by fixing the fixing portion 114 provided at a single location of the baffle plate 110 with the screw 108A. Therefore, attachment and removal of the baffle plate 110 may be simple, and a mounting task at a time of assembly of the optical scanning apparatus, attachment/removal tasks during maintenance and the like may be simple.

### Second Embodiment

Next, a second embodiment of the present invention will be described. Here, portions that are the same as in the first embodiment are assigned the same reference numerals and descriptions thereof are omitted, and only portions which differ from the first embodiment will be described.

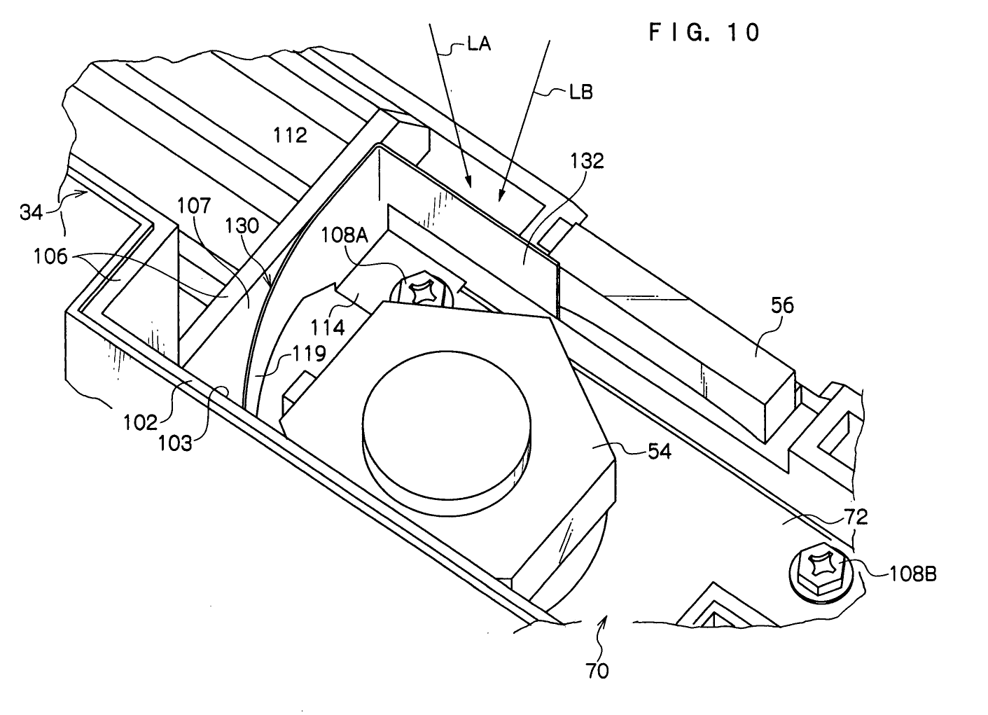

As shown in FIG. 10, a baffle plate 130 relating to this second embodiment is provided with a screen portion 132 at the one end portion 112. The screen portion 132 is formed to be inflected substantially at a right angle to the direction of inflection of the fixing portion 114 and protrudes to a predetermined length. When the baffle plate 130 is mounted by the same procedure as in the first embodiment described above, the screen portion 132 is disposed rightward and diagonally forward of the polygon mirror 54 as shown in the drawing, and a distal end portion of the screen portion 132 slightly overlaps with a side end portion of the f-θ lens 56.

Hence, in the present embodiment, stray light that occurs in the housing 34 (the arrows LA and LB of FIG. 10 and suchlike) is blocked by the screen portion 132 of the baffle plate 130 so as not to be incident on the polygon mirror 54. Therefore, a decrease in image quality which would be caused by such stray light being deflectingly scanned by the polygon mirror 54 may be suppressed. Furthermore, with the structure in which the screen portion 132 is integrally provided at the baffle plate 130 in this manner, it may be possible to keep structure simple in comparison with a case in which a dedicated screen member or the like featuring a screening function is separately provided.

### Third Embodiment

Next, a third embodiment of the present invention will be described. Here, portions that are the same as in the first embodiment are assigned the same reference numerals and descriptions thereof are omitted, and only portions which differ from the first embodiment will be described.

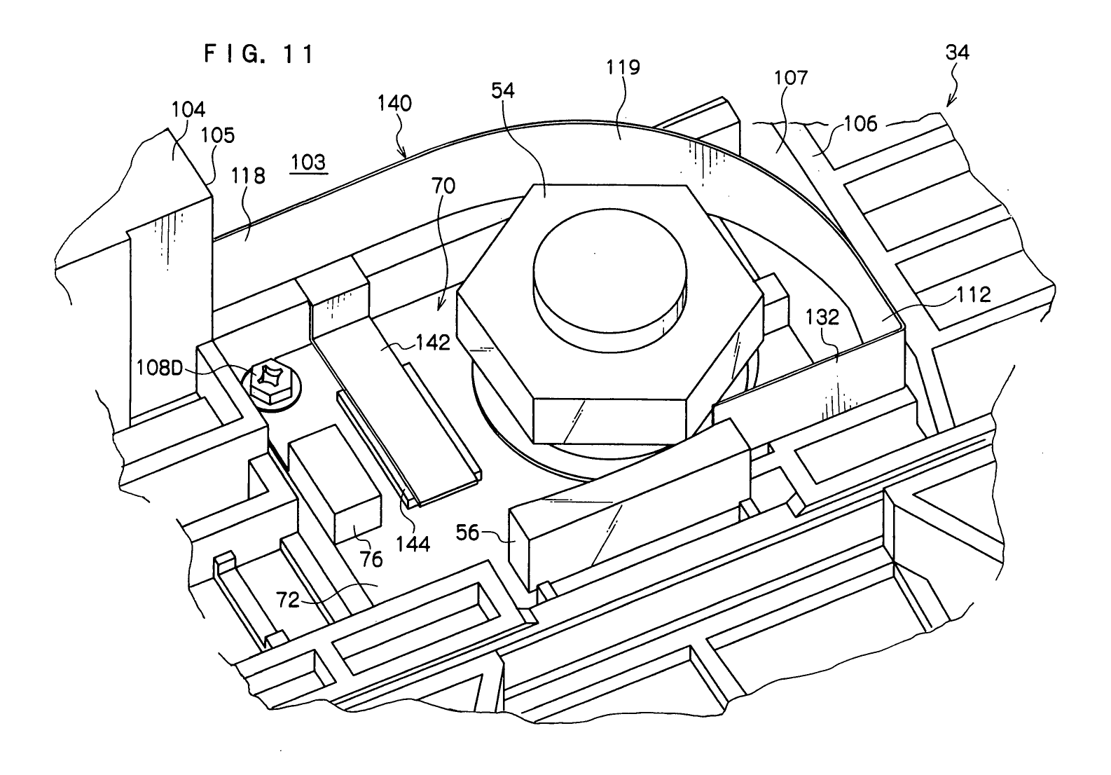

As shown in FIG. 11, a baffle plate 140 relating to this third embodiment is provided with a contacting portion 142 at a lower end portion of a predetermined position at the other end portion 118 side of the baffle plate 140. The contacting portion 142 is formed to be inflected in a direction the same as the direction of inflection of the fixing portion 114 (which is not shown in FIG. 11), to protrude to a predetermined length in a substantial crank shape (a Z shape). When the baffle plate 140 is mounted by the same procedure as in the first embodiment described above, the contacting portion 142 presses against an IC 144 mounted at the printed circuit board 72 of the optical deflector 70, as shown in the drawing, with silicone rubber or the like having high thermal conductivity interposed therebetween.

Hence, in the present embodiment, heat that is emitted from the IC 144, with a temperature rise when the optical deflector 70 is driven, is transmitted via the silicone rubber or the like and through the contacting portion 142 touching the IC 144 to the main body of the baffle plate 140, and is dissipated through the whole of the baffle plate 140. That is, this baffle plate 140 is formed to function as a heat sink. Further, this dissipation from the baffle plate 140 is promoted by airflows which are generated in accordance with rotation of the polygon mirror 54 (i.e., forced cooling). Further still, this baffle plate 140 is a metal plate with high thermal conductivity, and heat transmitted to the baffle plate 140 from the IC 144 is further transmitted to the housing 34, because the baffle plate 140 touches the inner wall face 103 and inner wall face 107 of the housing 34. Consequently, the dissipation is even further promoted. Thus, efficiency of cooling of the IC 144 may be raised, and, for example, a loss of dimensional precision of the various components due to thermal expansion, a loss of durability due to thermal stresses on the components mounted at the printed circuit board 72, and suchlike may be prevented.

### Fourth Embodiment

Next, a fourth embodiment of the present invention will be described.

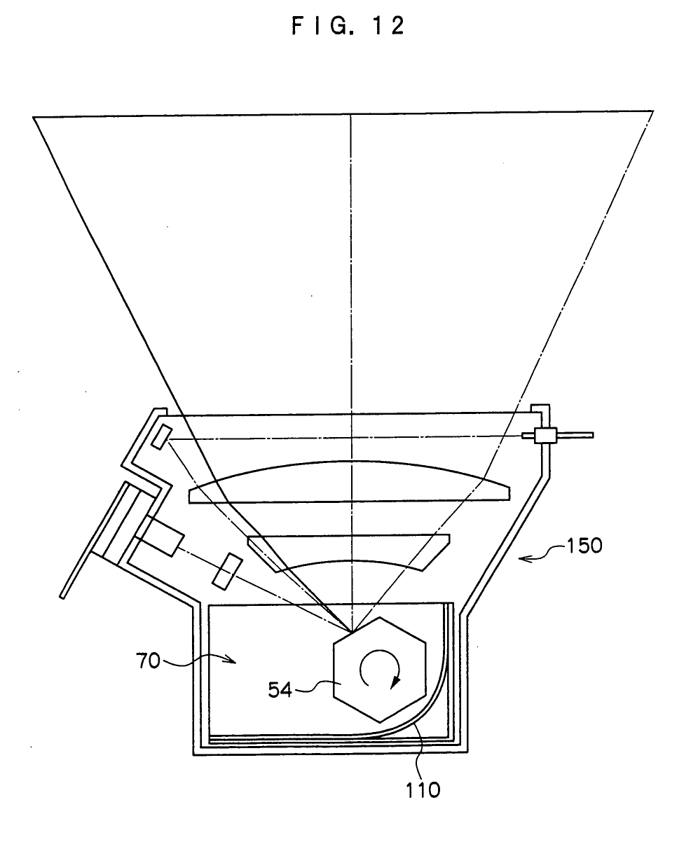

In this embodiment, the baffle plate 110 described for the first embodiment is employed at an optical scanning apparatus 150 in which, as shown in FIG. 12, a housing shape and optical system differ from the optical scanning apparatuses 28CK and 28YM of the first embodiment.

Because, as described above, the baffle plate 110 is a separate body from the housing and has flexibility, it is possible to easily adapt to a change in the shape of a housing or in the optical system or the like, or to a change in structure of the optical deflector or the like. Thus, versatility is increased.

To conclude, the present invention has been described in detail with the above-described first to fourth embodiments. However, the present invention is not limited to these embodiments, and various other embodiments can be implemented within the scope of the present invention.

For example, in the first to fourth embodiments, the baffle plate is curvingly deformed through substantially 90°, and is formed to oppose the outer peripheral faces of the polygon mirror 54. However, the angle of this curvature can be varied to be larger than 90°, or whatever, in accordance with the shape of the housing and suchlike. Furthermore, even in such cases, it is possible to adapt with ease simply by changing the shape of deformation of the baffle plate.

Further, the present invention is not limited to structures in which, as described above, the optical deflection apparatus and polygon mirror are disposed in a housing at a vicinity of outer side walls (such as the rear wall portion 102 and right side wall portion 106). For example, the present invention could be applied to an optical deflection apparatus with a structure such that the optical deflector and the polygon mirror are disposed near a central portion or the like, away from the outer side walls of the housing, but where there are vertical wall portions (interior wall faces) in a vicinity of the polygon mirror.

As described above, according to an aspect of the present invention, an optical scanning apparatus comprises: an optical deflector at which a light beam emitted from a light source is incident on a polygon mirror, and the polygon mirror is rotated for deflectingly scanning the light beam; an optical container accommodating the optical deflector, the optical deflector being disposed at a vicinity of an inner wall face of the optical container; and a baffle member disposed between an outer peripheral face of the polygon mirror and the inner wall face of the optical container, the baffle member regulating an airflow, which occurs along an outer periphery of the polygon mirror in accordance with the rotation.

According to another aspect of the present invention, the baffle member may have flexibility.

According to another aspect of the present invention, the optical scanning apparatus may further comprises a fixing portion that fixes the optical deflector at the optical container, the fixing portion being used for fixing the baffle member in association with the optical deflector.

According to another aspect of the present invention, the baffle member may be provided with the fixing portion in a single location.

According to another aspect of the present invention, the baffle member may comprise a metal plate.

According to another aspect of the present invention, the baffle member may comprise a screen portion, which screens so that stray light occurring in the optical container is not incident on the polygon mirror.

According to another aspect of the present invention, the baffle member may comprise a contacting portion, which touches a heat source portion provided at the optical deflector.

According to another aspect of the present invention, the baffle member may touch the inner wall face of the optical container.

According to another aspect of the present invention, an optical scanning apparatus comprises: an optical deflector at which a light beam emitted from a light source is incident on a polygon mirror, and the polygon mirror is rotated for deflectingly scanning the light beam; an optical container accommodating the optical deflector, the optical deflector being disposed at a vicinity of an inner wall face of the optical container; and a baffle member disposed between an outer peripheral face of the polygon mirror and the inner wall face of the optical container, the baffle member regulating an airflow, which occurs along an outer periphery of the polygon mirror in accordance with the rotation, wherein the baffle member has flexibility, a fixing portion that fixes the optical deflector at the optical container, the fixing portion being used for fixing the baffle member in association with the optical deflector, a screen portion is provided at the baffle member, the screen portion screening so that stray light occurring in the optical container is not incident on the polygon mirror, a contacting portion is provided at the baffle member, the contacting portion touching a heat source portion which is provided at the optical deflector, and the baffle member touches the inner wall face of the optical container.

According to another aspect of the present invention, an image formation device has an optical scanning apparatus, the image forming device forms an image by an electrophotography system with a light beam that is deflectingly scanned by the optical scanning apparatus, the optical scanning apparatus comprising: an optical deflector at which a light beam emitted from a light source is incident on a polygon mirror, and the polygon mirror is rotated for deflectingly scanning the light beam; an optical container accommodating the optical deflector, the optical deflector being disposed at a vicinity of an inner wall face of the optical container; and a baffle member disposed between an outer peripheral face of the polygon mirror and the inner wall face of the optical container, the baffle member regulating an airflow, which occurs along an outer periphery of the polygon mirror in accordance with the rotation.

According to another aspect of the present invention, An image formation device having an optical scanning apparatus, the image forming device forms an image by an electrophotography system with a light beam that is deflectingly scanned by the optical scanning apparatus, the optical scanning apparatus comprising: an optical deflector at which a light beam emitted from a light source is incident on a polygon mirror, and the polygon mirror is rotated for deflectingly scanning the light beam; an optical container accommodating the optical deflector, the optical deflector being disposed at a vicinity of an inner wall face of the optical container; and a baffle member disposed between an outer peripheral face of the polygon mirror and the inner wall face of the optical container, the baffle member regulating an airflow, which occurs along an outer periphery of the polygon mirror in accordance with the rotation.

According to another aspect of the present invention, an image formation device has an optical scanning apparatus, the image forming device forms an image by an electrophotography system with a light beam that is deflectingly scanned by the optical scanning apparatus, the optical scanning apparatus comprising: an optical deflector at which a light beam emitted from a light source is incident on a polygon mirror, and the polygon mirror is rotated for deflectingly scanning the light beam; an optical container accommodating the optical deflector, the optical deflector being disposed at a vicinity of an inner wall face of the optical container; and a baffle member disposed between an outer peripheral face of the polygon mirror and the inner wall face of the optical container, the baffle member regulating an airflow, which occurs along an outer periphery of the polygon mirror in accordance with the rotation, wherein the baffle member has flexibility, a fixing portion that fixes the optical deflector at the optical container, the fixing portion being used for fixing the baffle member in association with the optical deflector, a screen portion is provided at the baffle member, the screen portion screening so that stray light occurring in the optical container is not incident on the polygon mirror, a contacting portion is provided at the baffle member, the contacting portion touching a heat source portion which is provided at the optical deflector, and the baffle member touches the inner wall face of the optical container.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An optical scanning apparatus comprising:
an optical deflector at which a light beam emitted from a light source is incident on a polygon mirror, and the polygon mirror is rotated for deflectingly scanning the light beam;
an optical container accommodating the optical deflector, the optical deflector being disposed at a vicinity of an inner wall face of the optical container; and
a baffle member disposed between an outer peripheral face of the polygon mirror and the inner wall face of the optical container, the baffle member regulating an airflow, which occurs along an outer periphery of the polygon mirror in accordance with the rotation.

2. The optical scanning apparatus of claim 1, wherein the baffle member has flexibility.

3. The optical scanning apparatus of claim 1, further comprising a fixing portion that fixes the optical deflector at the optical container, the fixing portion being used for fixing the baffle member in association with the optical deflector.

4. The optical scanning apparatus of claim 2, further comprising a fixing portion that fixes the optical deflector at the optical container, the fixing portion being used for fixing the baffle member in association with the optical deflector.

5. The optical scanning apparatus of claim 3, wherein the baffle member is provided with the fixing portion in a single location.

6. The optical scanning apparatus of claim 4, wherein the baffle member is provided with the fixing portion in a single location.

7. The optical scanning apparatus of claim 1, wherein the baffle member comprises a metal plate.

8. The optical scanning apparatus of claim 1, wherein the baffle member comprises a screen portion, which screens so that stray light occurring in the optical container is not incident on the polygon mirror.

9. The optical scanning apparatus of claim 2, wherein the baffle member comprises a screen portion, which screens so that stray light occurring in the optical container is not incident on the polygon mirror.

10. The optical scanning apparatus of claim 3, wherein the baffle member comprises a screen portion, which screens so that stray light occurring in the optical container is not incident on the polygon mirror.

11. The optical scanning apparatus of claim 4, wherein the baffle member comprises a screen portion, which screens so that stray light occurring in the optical container is not incident on the polygon mirror.

12. The optical scanning apparatus of claim 5, wherein the baffle member comprises a screen portion, which screens so that stray light occurring in the optical container is not incident on the polygon mirror.

13. The optical scanning apparatus of claim 6, wherein the baffle member comprises a screen portion, which screens so that stray light occurring in the optical container is not incident on the polygon mirror.

14. The optical scanning apparatus of claim 7, wherein the baffle member comprises a screen portion, which screens so that stray light occurring in the optical container is not incident on the polygon mirror.

15. The optical scanning apparatus of claim 1, wherein the baffle member comprises a contacting portion, which touches a heat source portion provided at the optical deflector.

16. The optical scanning apparatus of claim 2, wherein the baffle member comprises a contacting portion, which touches a heat source portion provided at the optical deflector.

17. The optical scanning apparatus of claim 3, wherein the baffle member comprises a contacting portion, which touches a heat source portion provided at the optical deflector.

18. The optical scanning apparatus of claim 4, wherein the baffle member comprises a contacting portion, which touches a heat source portion provided at the optical deflector.

19. The optical scanning apparatus of claim 5, wherein the baffle member comprises a contacting portion, which touches a heat source portion provided at the optical deflector.

20. The optical scanning apparatus of claim 6, wherein the baffle member comprises a contacting portion, which touches a heat source portion provided at the optical deflector.

21. The optical scanning apparatus of claim 7, wherein the baffle member comprises a contacting portion, which touches a heat source portion provided at the optical deflector.

22. The optical scanning apparatus of claim 15, wherein the baffle member touches the inner wall face of the optical container.

23. An optical scanning apparatus comprising:
an optical deflector at which a light beam emitted from a light source is incident on a polygon mirror, and the polygon mirror is rotated for deflectingly scanning the light beam;
an optical container accommodating the optical deflector, the optical deflector being disposed at a vicinity of an inner wall face of the optical container; and
a baffle member disposed between an outer peripheral face of the polygon mirror and the inner wall face of the optical container, the baffle member regulating an airflow, which occurs along an outer periphery of the polygon mirror in accordance with the rotation,
wherein
the baffle member has flexibility,
a fixing portion that fixes the optical deflector at the optical container, the fixing portion being used for fixing the baffle member in association with the optical deflector,
a screen portion is provided at the baffle member, the screen portion screening so that stray light occurring in the optical container is not incident on the polygon mirror,
a contacting portion is provided at the baffle member, the contacting portion touching a heat source portion which is provided at the optical deflector, and
the baffle member touches the inner wall face of the optical container.

24. An image formation device having an optical scanning apparatus, the image forming device forms an image by an electrophotography system with a light beam that is deflectingly scanned by the optical scanning apparatus, the optical scanning apparatus comprising: an optical deflector at which a light beam emitted from a light source is incident on a polygon mirror, and the polygon mirror is rotated for deflectingly scanning the light beam;
an optical container accommodating the optical deflector, the optical deflector being disposed at a vicinity of an inner wall face of the optical container; and
a baffle member disposed between an outer peripheral face of the polygon mirror and the inner wall face of the optical container, the baffle member regulating an airflow, which occurs along an outer periphery of the polygon mirror in accordance with the rotation.

25. An image formation device having an optical scanning apparatus, the image forming device forms an image by an electrophotography system with a light beam that is deflectingly scanned by the optical scanning apparatus, the optical scanning apparatus comprising: an optical deflector at which a light beam emitted from a light source is incident on a polygon mirror, and the polygon mirror is rotated for deflectingly scanning the light beam;
an optical container accommodating the optical deflector, the optical deflector being disposed at a vicinity of an inner wall face of the optical container; and
a baffle member disposed between an outer peripheral face of the polygon mirror and the inner wall face of the optical container, the baffle member regulating an airflow, which occurs along an outer periphery of the polygon mirror in accordance with the rotation,
wherein
the baffle member has flexibility,
a fixing portion that fixes the optical deflector at the optical container, the fixing portion being used for fixing the baffle member in association with the optical deflector,
a screen portion is provided at the baffle member, the screen portion screening so that stray light occurring in the optical container is not incident on the polygon mirror,
a contacting portion is provided at the baffle member, the contacting portion touching a heat source portion which is provided at the optical deflector, and
the baffle member touches the inner wall face of the optical container.
